(19) United States
(12) Patent Application Publication
(10) Pub. No.: US 2026/0147097 A1
(43) Pub. Date: May 28, 2026

(54) ROTARY SUPPORT FOR LIDAR AND LIDAR

(71) Applicant: HESAI TECHNOLOGY CO., LTD., Shanghai (CN)

(72) Inventors: Shanhui FENG, Shanghai (CN); Jie CHEN, Shanghai (CN); Hui NIE, Shanghai (CN); Jinming TIAN, Shanghai (CN); Jinsong CHEN, Shanghai (CN); Shaoqing XIANG, Shanghai (CN)

(21) Appl. No.: 19/453,311

(22) Filed: Jan. 20, 2026

Related U.S. Application Data
(63) Continuation of application No. PCT/CN2024/106611, filed on Jul. 19, 2024.

(30) Foreign Application Priority Data
Jul. 20, 2023 (CN) 202310896488.X
Jul. 20, 2023 (CN) 202310896713.X

(51) Int. Cl. G01S 7/481; G01D 5/347

(52) U.S. Cl. CPC G01S 7/4817; G01D 5/34715; G01S 7/4813

(57) ABSTRACT

This disclosure provides a rotary support for a LiDAR and the LiDAR. The rotary support includes a housing, a central shaft, a bearing support, and a driver. The housing is provided with an accommodating cavity. The central shaft is disposed in the accommodating cavity, and the central shaft is fixed relative to the housing. The bearing support is mated with the central shaft via a bearing. The driver is configured to drive the bearing support to rotate. The driver includes a stator and a rotor. The rotor includes an electromagnetic component, and the electromagnetic component is fixed to an outer side wall of the bearing support. The stator includes a magnetic component, and the magnetic component is disposed on an outer side of the electromagnetic component and fixed relative to the housing.

### CROSS-REFERENCE TO RELATED APPLICATIONS

This application is a continuation application of PCT Application No. PCT/CN 2024/106611, filed on Jul. 19, 2024, which claims priorities to Chinese Patent Application No. 202310896713.X, filed Jul. 20, 2023 and Chinese Patent Application No. 202310896488.X, filed on Jul. 20, 2023. The disclosures of the aforementioned applications are hereby incorporated by reference in their entireties.

### TECHNICAL FIELD

This disclosure relates to the field of LiDAR and, in particular, to a rotary support for a LiDAR and the LiDAR.

### BACKGROUND

Light Detection and Ranging (“LiDAR”) is typically classified into mechanical rotating LiDAR, forward-looking LiDAR with scanning devices, and solid-state LiDAR. A mechanical rotating LiDAR refers to a LiDAR, an emitting device and a receiving device of which rotate at 360°. The mechanical rotating LiDAR drives multiple laser emitters arranged in a vertical direction to rotate continuously in a horizontal direction to scan a surrounding environment.

The mechanical rotating LiDAR includes a rotary support and a detection device disposed on the rotary support. The detection device includes an emitting device and a receiving device. The rotary support drives the detection device to rotate to detect the surrounding environment of the LiDAR. The mechanical rotating LiDAR has advantages of a 360-degree field of view in the horizontal direction, or the like.

However, certain drawbacks exist in the existing mechanical rotating LiDAR. For example, a structure of the rotary support is not sufficiently compact, arrangement of elements is not well optimized, radial spacing between modules on a circuit board is large, and the number of axially arranged elements is relatively large. These drawbacks increase a size and cost of the LiDAR, which is unfavorable to assembly and mass production.

### SUMMARY

Based on a rotary support for a LiDAR and the LiDAR provided by this disclosure, without affecting performance of the LiDAR, a structure of the LiDAR can be compact, arrangement of elements can be more optimized, radial spacing between modules on a circuit board can be decreased, the number of axially arranged elements can be decreased, and a peripheral size and cost of the LiDAR can be decreased, thereby facilitating assembly and mass production of the LiDAR.

In a first aspect, embodiments of this disclosure provide a rotary support for a LiDAR, including a housing, a central shaft, a bearing support, and a driver. The housing is provided with an accommodating cavity. The central shaft is disposed in the accommodating cavity and fixed relative to the housing. The bearing support is disposed in the accommodating cavity and mated with the central shaft via a bearing, such that the bearing support is capable of rotating relative to the central shaft. The driver is disposed in the accommodating cavity and configured to drive the bearing support to rotate. The driver includes a stator and a rotor. The rotor includes an electromagnetic component, and the electromagnetic component is fixed to a side wall of the bearing support. The stator includes a magnetic component, and the magnetic component is disposed on an outer side of the electromagnetic component and fixed relative to the housing.

Optionally, the electromagnetic component is disposed around the bearing support, and the magnetic component is disposed around the electromagnetic component and is radially opposite to the electromagnetic component.

Optionally, the rotary support further includes a stator fixing member. The stator fixing member is fixed relative to the housing. The magnetic component is fixed on the stator fixing member.

Optionally, the magnetic component is of an annular structure. The stator fixing member is disposed around a peripheral surface of the magnetic component.

Optionally, the rotary support further includes a wireless power supplier module. The wireless power supplier module is configured to supply power to a component rotating with the bearing support in the LiDAR.

Optionally, the wireless power supplier module includes an emitting coil and a receiving coil. The emitting coil is fixed relative to the housing. The receiving coil is disposed axially opposite to the emitting coil, and configured to rotate with the bearing support.

Optionally, the rotary support further includes a lower circuit board. The lower circuit board is fixed relative to the housing and disposed around the central shaft or the bearing or the bearing support. The emitting coil is disposed on the lower circuit board to supply power to the emitting coil via the lower circuit board.

Optionally, the rotary support further includes an emitting coil fixing member. The emitting coil fixing member is disposed around a peripheral surface of the stator fixing member. The emitting coil fixing member is configured to fix the emitting coil and is disposed between the stator fixing member and the emitting coil.

Optionally, the magnetic component and the emitting coil fixing member are disposed on the stator fixing member. The stator fixing member is fixedly connected to the housing.

Optionally, the emitting coil fixing member is made of an insulating material.

Optionally, the rotary support further includes a rotary support member. The rotary support member is fixed relative to the bearing support. The detection device of the LiDAR is mounted on the rotary support member.

Optionally, the housing includes a bottom and a side wall disposed around the bottom. The rotary support further includes a position detector module. The position detector module is configured to detect rotational position information of the detection device. The position detector module includes a code disc and a code reader. The code disc is disposed around an inner surface of the side wall. The code disc is provided with a code track. The code reader is fixed relative to the rotary support member and disposed radially opposite to the code disc. The code reader rotates with the rotary support member to detect the code track on the code disc.

Optionally, an extension direction of the code track is parallel to the central shaft.

Optionally, an upper circuit board is disposed between the rotary support member and the detection device. The code reader is fixed on the upper circuit board.

Optionally, a code reader circuit board is disposed below the upper circuit board. The code reader is disposed on the code reader circuit board.

Optionally, the upper circuit board is perpendicular to the central shaft. The code reader circuit board is parallel to the central shaft.

Optionally, the upper circuit board is further provided with a processor. The processor is electrically connected to the code reader to process the rotational position information acquired by the code reader.

Optionally, the rotary support further includes a middle circuit board and the lower circuit board. The middle circuit board is disposed on the rotary support member and located between the upper circuit board and the lower circuit board. The middle circuit board is disposed around the central shaft or the bearing or the bearing support, and the middle circuit board is capable of supplying power to the upper circuit board and the electromagnetic component.

Optionally, the rotary support further includes a wireless power supplier module. The receiving coil of the wireless power supplier module is also disposed on the rotary support member, and the receiving coil and the middle circuit board are disposed on two sides of the rotary support member, respectively.

Optionally, a gap between the code reader and the code disc is smaller than a width of the code disc in an axial direction.

Optionally, the driver, the wireless power supplier module, and the position detector module are disposed around the central shaft. The driver, the wireless power supplier module, and the position detector module are sequentially disposed in a direction away from the central shaft.

Optionally, a flange extends outwardly from a side wall of the bearing support. The rotary support member is connected to the flange of the bearing support.

Optionally, there is a predetermined distance between the flange and a first end surface of the bearing support. The rotary support member is disposed between the flange and the first end surface.

Optionally, the rotary support further includes an optical communication circuit board, an uplink wireless communication emitter, a downlink wireless communication receiver, an uplink wireless communication receiver, and a downlink wireless communication emitter. The optical communication circuit board is disposed on the housing. The uplink wireless communication emitter and the downlink wireless communication receiver are both disposed on the optical communication circuit board. The uplink wireless communication receiver and the downlink wireless communication emitter are both disposed on the upper circuit board. The uplink wireless communication emitter and the uplink wireless communication receiver are configured to perform an uplink optical communication, and the uplink optical communication is implemented in the central shaft. The downlink wireless communication emitter and the downlink wireless communication receiver are configured to perform a downlink optical communication, and the downlink optical communication is implemented in the central shaft.

Optionally, the bearing includes a first bearing and a second bearing. The first bearing and the second bearing are disposed at two ends of the central shaft, respectively, and an inner ring of the first bearing and an inner ring of the second bearing are sleeved at both ends of the central shaft, respectively. The bearing support includes a first bearing chamber and a second bearing chamber. An outer ring of the first bearing is fixed to the first bearing chamber. An outer ring of the second bearing is fixed to the second bearing chamber.

Optionally, the electromagnetic component is provided with a first snap-fit portion. The bearing support is provided with a second snap-fit portion. The first snap-fit portion is snap-fitted to the second snap-fit portion.

In a second aspect, the embodiments of this disclosure provide a LiDAR. The LiDAR includes the rotary support in any one embodiment in the above first aspect and a detection device. The detection device is disposed on the rotary support. The rotary support drives the detection device to rotate to detect a periphery of the LiDAR.

Optionally, the detection device includes a lens barrel, an optical emitter, an optical receiver, and a drive circuit board. The lens barrel is configured to accommodate an emitting lens group and a receiving lens group. The lens barrel is made of plastic. The optical emitter is configured to emit detection light. The emitting lens group is located on a light path of the detection light. The optical receiver is configured to receive echo light reflected by a target object from the detection light. The receiving lens group is located on a light path of the echo light. The optical emitter and the optical receiver are both disposed on the drive circuit board.

Optionally, the detection device includes the lens barrel. The lens barrel includes a lens barrel body. The lens barrel body includes an emitting cavity, a receiving cavity, and a first light barrier. The emitting cavity is formed in the lens barrel body and configured to accommodate the emitting lens group. The receiving cavity is formed in the lens barrel body and configured to accommodate the receiving lens group. The first light barrier is disposed between the emitting cavity and the receiving cavity to separate the emitting cavity and the receiving cavity.

Optionally, the lens barrel body and the first light barrier are integrally formed.

Optionally, an optical axis of the emitting lens group is parallel to an optical axis of the receiving lens group.

Optionally, the lens barrel body comprises multiple lens barrel sections in a direction perpendicular to the drive circuit board. Inner diameters of the lens barrel sections being different to match at least one of emitting lenses or receiving lenses of different sizes, and wall thicknesses of the lens barrel sections being the same.

Optionally, the lens barrel body includes an emitting port, a receiving port, a mounting portion, and a second light barrier. The emitting port is located on a light path of the detection light and located downstream of the emitting cavity. The receiving port is located on a light path of the echo light and located upstream of the receiving cavity. The mounting portion is located between the emitting port and the receiving port. The second light barrier is mounted outside the lens barrel body through the mounting portion, to isolate the detection light and the echo light outside the lens barrel body.

Optionally, the lens barrel is made of a fiber-enhanced polyphenylene sulfide (PPS) plastic.

Optionally, the lens barrel is made of a glass fiber-enhanced PPS plastic. A content of glass fiber in the glass fiber-enhanced PPS plastic is 40%.

Optionally, the detection device further includes a heat dissipation member. The heat dissipation member is disposed at an end of the lens barrel and configured to dissipate heat of at least one of the drive circuit board and the lens barrel.

Optionally, the drive circuit board is disposed between the lens barrel and the heat dissipation member.

Optionally, the heat dissipation member includes a heat dissipation fin group. The heat dissipation fin group is connected to at least one of the drive circuit board and the lens barrel.

Optionally, the detection device further includes a base. The lens barrel is mounted on the base.

Optionally, the optical axis of the emitting lens group and the optical axis of the receiving lens group in the lens barrel are obliquely disposed relative to the base.

Optionally, a vertical field of view of the detection device is greater than or equal to 105°.

Optionally, the lens barrel includes the lens barrel body and support bodies. The lens barrel body is obliquely disposed relative to the base. The support bodies are integrally formed with the lens barrel body and connected to the base. The support bodies are disposed on two sides of the lens barrel body and configured to support the lens barrel body, the drive circuit board, and the heat dissipation member.

Optionally, reinforcing ribs are disposed on the support bodies. The reinforcing ribs are integrally formed with the support bodies.

Optionally, a channel is disposed on the lens barrel body. An inlet end of the channel is in communication with an outside of the lens barrel body. An outlet end of the channel is in communication with at least one of an emitting lens or a receiving lens in the lens barrel body to guide an adhesive to enter a connection between a lens and the lens barrel body.

Optionally, a cross-sectional area of the inlet end of the channel is greater than a cross-sectional area of an interior of the channel.

Optionally, the lens barrel includes a first positioning portion and a second positioning portion. The first positioning portion is configured to position the lens barrel and at least one of the drive circuit board and the heat dissipation member. The second positioning portion is configured to position the lens barrel and the base.

Optionally, the upper circuit board is disposed on one side of the base away from the lens barrel. The upper circuit board is provided with an electrical connector. The base is provided with a hole. The electrical connector passes through the hole and is electrically connected to the upper circuit board.

Optionally, the optical emitter is a vertical cavity surface emitting laser (VCSEL). The optical receiver is a single-photon detector.

The rotary support for the LiDAR and the LiDAR provided by the embodiments of this disclosure at least have the following beneficial effects.

In some embodiments, based on the rotary support provided by the embodiments of this disclosure, the electromagnetic component is disposed on the rotor, and the magnetic component is disposed on the stator. In such a case, the rotor is electrified to generate a magnetic field. Driven by interaction between this magnetic field and a magnetic field of the magnetic component of the stator, the rotor and the bearing support rotate. Moreover, the electromagnetic component in this structure is directly fixed to the side wall of the bearing support and rotates with the bearing support. Accordingly, a gap between the electromagnetic component and the bearing support can be omitted, and the peripheral size of the rotary support can also be decreased. In such a case, the structure of the LiDAR is more compact, and the peripheral size of the LiDAR is decreased without affecting the performance of the LiDAR, thereby facilitating the assembly and the mass production of the LiDAR.

In some embodiments, the emitting coil fixing member is disposed in the rotary support provided by the embodiments of this disclosure to fix the emitting coil. The emitting coil fixing member is disposed around a peripheral surface of the stator fixing member, and the emitting coil fixing member is disposed between the stator fixing member and the emitting coil. A circuit board that supplies power to the emitting coil is omitted in this structure. Accordingly, the number of the axially arranged elements is decreased, and a height of the LiDAR is decreased.

In some embodiments, in the rotary support provided by the embodiments of this disclosure, the code disc of the position detector module is disposed around an inner surface of the side wall of the housing. The code reader of the position detector module is fixed relative to the rotary support member and disposed radially opposite to the code disc. The code reader rotates with the rotary support member to detect the code track on the code disc. In such a case, space occupied by a surface of the code disc provided with the code track is transformed from radial space to axial space, thereby further decreasing the peripheral size of the rotary support.

In some embodiments, in the rotary support provided by the embodiments of this disclosure, the upper circuit board is provided with the processor. The processor is electrically connected to the code reader to process the rotational position information acquired by the code reader. Therefore, the processor of the upper circuit board can directly process position information detected by the position detector module. In such a case, the number of elements on the lower circuit board, and the size and manufacturing costs of the lower circuit board can be decreased, thereby decreasing the peripheral size of the LiDAR.

In some embodiments, in the rotary support provided by the embodiments of this disclosure, the flange extends outwardly from the side wall of the bearing support, and there is the predetermined distance between the flange and the first end surface of the bearing support. The rotary support member is disposed between the flange and the first end surface. In such a case, the axial space occupied by the rotary support member can be saved.

In some embodiments, the LiDAR provided by the embodiments of this disclosure can use the rotary support in any one of the above embodiments. In such a case, the peripheral size of the rotary support can be decreased, thereby decreasing the peripheral size of the LiDAR. Moreover, without affecting the performance of the LiDAR, the structure of the LiDAR can be compact, the arrangement of the elements can be more rational, the radial clearances between the modules on the circuit board can be decreased, and the number of the axially arranged elements is decreased, and the peripheral size and the costs of the LiDAR are decreased, thereby facilitating the assembly and the mass production of the LiDAR.

In some embodiments, in the detection device included in the LiDAR provided by the embodiments of this disclosure, the optical emitter and the optical receiver can both be disposed on the same drive circuit board (e.g., a structure using an emitter-receiver shared board). In the structure using the emitter-receiver shared board, the lens barrel can use an emitter-receiver integrated design (e.g., the emitting lens barrel and the receiving lens barrel are merged into the same lens barrel). When the integrated lens barrel is mounted in cooperation with the emitter-receiver shared board of the optical emitter and the optical receiver, alignment-free assembly can be achieved, thereby facilitating mass production. Moreover, the lens barrel is made of plastic, such that a weight of the lens barrel is decreased, processing costs are lowered, production efficiency is improved, and size consistency of a product is better.

In some embodiments, in the detection device included in the LiDAR provided by the embodiments of this disclosure, the first light barrier is integrally formed with the lens barrel body. This approach can simplify production and assembly processes, and can improve production efficiency, thereby facilitating the mass production of the LiDAR. Moreover, an integrally formed structure is higher in strength and durability, thereby improving reliability of the LiDAR during long-time rotation and prolonging a service life of the LiDAR.

In some embodiments, in the detection device included in the LiDAR provided by the embodiments of this disclosure, the lens barrel body comprises multiple lens barrel sections in a direction perpendicular to the drive circuit board. The inner diameters of the lens barrel sections are different to match at least one of the emitting lens or the receiving lens of different sizes. The wall thicknesses of the lens barrel sections are the same, such that it can ensure that the strength of the lens barrel body is consistent throughout in the direction perpendicular to the drive circuit board, thereby reducing local deformation of the lens barrel body. Moreover, when using plastic material, this lens barrel structure can be implemented by an injection molding process, resulting in low production costs, good product consistency, and ease of mass production.

In some embodiments, in the detection device included in the LiDAR provided by the embodiments of this disclosure, the lens barrel is made of the fiber-enhanced PPS plastic. Compared with a common PPS plastic, the fiber-enhanced PPS plastic can improve corresponding performance of the material based on actual needs, such that the lens barrel can receive advantages of higher mechanical strength, better insulating property, corrosion resistance, high-temperature resistance, or the like.

In some embodiments, in the detection device included in the LiDAR provided by the embodiments of this disclosure, the detection device in any one of the above embodiments is used. Accordingly, the weight of the LiDAR can be decreased, and the pressure of the rotary support that supports the detection device is decreased, such that rotating stability of the rotary support is improved, thereby improving the reliability of the LiDAR and prolonging the service life of the LiDAR. Moreover, the costs of the LiDAR can be lowered and the production efficiency of the LiDAR can be increased, thereby facilitating the mass production of the LiDAR.

### BRIEF DESCRIPTION OF THE DRAWINGS

To describe technical solutions of embodiments of this specification more clearly, drawings to be used in the embodiments will be briefly introduced below, and it is apparent that the drawings described below are merely some of the embodiments of this disclosure, and that other drawings can also be received based on these drawings for those ordinary skilled in the art without creative labor.

FIG. 1 shows a sectional view of a rotary support, provided in some embodiments of this disclosure;

FIG. 2 shows an exploded view of a rotary support, provided in some embodiments of this disclosure;

FIG. 3 shows an exploded view of a portion A in FIG. 2, provided in this disclosure;

FIG. 4 shows a schematic structural diagram where a bearing support is mated with an electromagnetic component in a rotary support, provided in some embodiments of this disclosure;

FIG. 5 shows a schematic structural diagram where a driver and a wireless power supplier module are not mounted in a rotary support, provided in some embodiments of this disclosure;

FIG. 6 shows a schematic diagram of a position detector module in a rotary support, provided in some embodiments of this disclosure;

FIG. 7 shows a schematic structural diagram of a detection device in a LiDAR, provided in some embodiments of this disclosure;

FIG. 8 shows a schematic structural diagram of an upper circuit board in a LiDAR, provided in some embodiments of this disclosure;

FIG. 9 shows a schematic structural diagram of a LiDAR, provided in some embodiments of this disclosure;

FIG. 10 shows a schematic structural diagram of a detection device, provided in some embodiments of this disclosure;

FIG. 11 shows an external schematic structural diagram of a detection device, provided in some embodiments of this disclosure;

FIG. 12 shows an external schematic structural diagram of a lens barrel in a detection device, provided in some embodiments of this disclosure;

FIG. 13 shows a sectional view of a detection device, provided in some embodiments of this disclosure;

FIG. 14 shows an enlarged view of a portion B in FIG. 13, provided in this disclosure;

FIG. 15 shows an exploded view of a base and a control circuit board in a detection device, provided in some embodiments of this disclosure; and

FIG. 16 shows an exploded view of a detection device, provided in some embodiments of this disclosure.

### DETAILED DESCRIPTION

The following description provides specific application scenarios and requirements for this disclosure, with a purpose of enabling those skilled in the art to manufacture and use contents of this disclosure. For those skilled in the art, various partial modifications to disclosed embodiments are obvious, and general principles defined herein can be applied to other embodiments and applications without departing from spirit and scope of this disclosure. Accordingly, this disclosure is not limited to shown embodiments, but is a widest scope consistent with claims.

Terms used herein are merely for a purpose of describing specific illustrative embodiments rather than restrictive. For example, unless otherwise explicitly stated in the context, singular forms “a,” “one,” and “this” used herein can also include plural forms. When used in this disclosure, at least one of terms “including,” “comprising,” and “containing” refer that at least one of associated integers, steps, operations, elements, and components are existed, but do not exclude existence of at least one of one or more other features, integers, steps, operations, elements, components, and groups or that at least one of other features, integers, steps, operations, elements, components, and groups can be added to this system/method.

In this disclosure, terms “upper,” “lower,” “left,” “right,” “front,” “rear,” “top,” “bottom,” “inner,” “outer,” “vertical,” “horizontal,” “transverse,” and “longitudinal” indicate an orientation or positional relationship based on an orientation or positional relationship shown in accompanying drawings. These terms are mainly intended to better describe this disclosure and the embodiments thereof, and are not used to limit indicated devices, elements or components to having specific orientations, or to being constructed and operated in specific orientations.

Furthermore, in addition to indicating the orientation or positional relationship, some of the above terms can also have other meanings. For example, a term “upper” can denote a certain dependency or connection relationship in some conditions. For those ordinary skilled in the art, specific meanings of these terms in this disclosure can be understood based on a specific situation.

In addition, terms “mount,” “dispose,” “provide,” “connection” and “connected” shall be interpreted in a broad sense. For example, it can be fixedly connected, detachably connected or integrally configured; it can be mechanically connected or electrically connected; it can be directly connected or indirectly connected through an intermediate medium, or it can be internal communication between two devices, elements, or components. For those of ordinary skill in the art, specific meanings of the above terms in this disclosure can be understood based on the specific situation.

Considering the following description, these features and other features of this specification, as well as operations and functions of relevant elements of a structure, a combination of components, and economics of manufacturing can be significantly improved. Refer to the accompanying drawings, all of which form a part of this disclosure. However, it should be clearly understood that the accompanying drawings are merely for illustrative and descriptive purposes and are not intended to limit a scope of this disclosure. It should also be understood that the accompanying drawings are not drawn to scale.

To solve problems that a structure of a rotary support in the existing technology is not compact, arrangement of internal elements is not well optimized, radial spacing between modules on a circuit board is large, the number of axially arranged elements is large, and a peripheral size and costs of a LiDAR are increased, thereby affecting assembly and mass production of the LiDAR, this disclosure provides a rotary support for a LiDAR. The rotary support includes a housing, a central shaft, a bearing support, and a driver. The housing is provided with an accommodating cavity. The central shaft is disposed in the accommodating cavity and fixed relative to the housing. The bearing support is disposed in the accommodating cavity and mated with the central shaft via a bearing, such that the bearing support is capable of rotating relative to the central shaft. The driver is disposed in the accommodating cavity and configured to drive the bearing support to rotate. The driver includes a stator and a rotor. The rotor includes an electromagnetic component. The electromagnetic component is fixed to a side wall of the bearing support. The stator includes a magnetic component. The magnetic component is disposed on an outer side of the electromagnetic component and fixed relative to the housing.

Based on the rotary support provided by the embodiments of this disclosure, the electromagnetic component is disposed on the rotor, and the magnetic component is disposed on the stator. In such a case, the rotor is electrified to generate a magnetic field. Driven by interaction between this magnetic field and a magnetic field of the magnetic component of the stator, the rotor and the bearing support rotate. Moreover, the electromagnetic component in this structure is directly fixed to the side wall of the bearing support and rotates with the bearing support. Accordingly, a gap between the electromagnetic component and the bearing support can be omitted, and the peripheral size of the rotary support can also be decreased. In such a case, the structure of the LiDAR is more compact, and the peripheral size of the LiDAR is decreased without affecting performance of the LiDAR, thereby facilitating the assembly and the mass production of the LiDAR. This disclosure is described in detail below through specific embodiments.

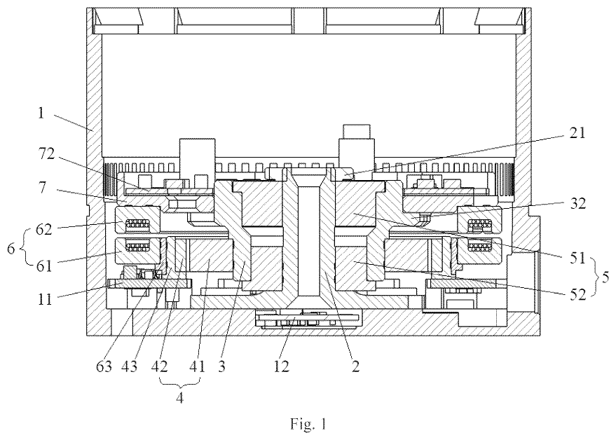

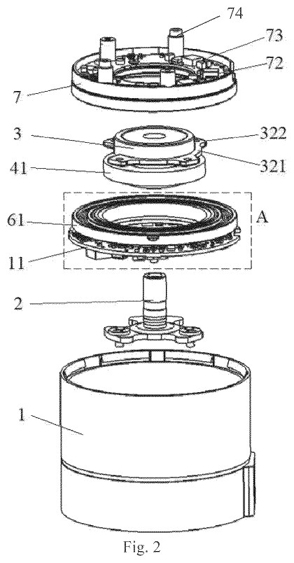

As shown in FIG. 1 and FIG. 2, this disclosure provides an example of a rotary support for a LiDAR. The rotary support includes a central shaft 2, a bearing 5 is sleeved on a periphery of the central shaft 2, and a bearing support 3 is disposed on a periphery of the bearing 5. Among them, the bearing 5 includes a first bearing 51 and a second bearing 51, and the first bearing 51 and the second bearing 52 are disposed at two ends of the central shaft 2, respectively. An inner ring of the first bearing 51 and an inner ring of the second bearing 52 are both sleeved on the central shaft 2 and are in clearance fit with the central shaft 2. Correspondingly, the bearing support 3 includes a first bearing chamber and a second bearing chamber. The first bearing chamber and the second bearing chamber refer to space configured to accommodate the bearing 5. For example, an outer ring of the first bearing 51 is in interference fit with the first bearing chamber, and an outer ring of the second bearing 52 is in interference fit with the second bearing chamber, such that outer rings of bearings and the bearing support 3 can rotate synchronously relative to the central shaft 2.

In some embodiments, when the bearing support 3 is assembled, an assembly process is as follows. First, the outer rings of the first bearing 51 and the second bearing 52 are fixed to the first bearing chamber and the second bearing chamber of the bearing support 3 through interference fit, respectively. Then, the bearing support 3 provided with the first bearing 51 and the second bearing 52 is integrally sleeved on the central shaft 2, such that the inner rings of the first bearing 51 and the second bearing 52 are in clearance fit with the central shaft 2. Moreover, the central shaft 2 is connected to and supports the second bearing 2 in an axial direction, such that the central shaft 2 supports the bearing support 3 provided with the first bearing 51 and the second bearing 52 in the axial direction. Finally, the inner ring of the first bearing 51 is locked by a locking member 21, such as a snap ring, to prevent the bearing 5 and the bearing support 3 from moving in an axial direction of the central shaft 2.

As shown in FIG. 1, a driver 4 is disposed on an outer side of the bearing support 3. The driver 4 includes a stator and a rotor. The rotor includes an electromagnetic component 41. The stator includes a magnetic component 42. The electromagnetic component 41 is fixed on a side wall of the bearing support 3. The magnetic component 42 is disposed on an outer side of the electromagnetic component 41 and fixed relative to a housing 1. A detection device (not shown in the figure) of the LiDAR is fixed relative to the bearing support 3, and the driver 4 drives the bearing support 3 to rotate, such that the bearing support 3 drives the detection device to rotate at 360° in a horizontal direction. In such a case, 360° detection of the LiDAR is implemented. Among them, the driver 4 disposes the electromagnetic component 41 on the rotor, and disposes the magnetic component 42 on the stator. In such a case, the magnetic component 42 is electrified to generate the magnetic field, and driven by the interaction between this magnetic field and the magnetic field of the magnetic component 42 of the stator, the rotor and the bearing support 3 rotate. Moreover, the electromagnetic component 41 in this structure is directly fixed to the side wall of the bearing support 3, and rotates with the bearing support 3. Accordingly, a gap between the electromagnetic component 41 and the bearing support 3 can be omitted, and the peripheral size of the rotary support can also be decreased. In such a case, the structure of the LiDAR is more compact, and the peripheral size of the LiDAR is decreased without affecting the performance of the LiDAR, thereby facilitating the assembly and the mass production of the LiDAR.

In some embodiments, the above electromagnetic component 41 may be determined as an annular structure and disposed around the bearing support 3. A height of the electromagnetic component 41 in the axial direction can be substantially close to a height of the second bearing 52. The magnetic component 42 can be correspondingly determined as an annular structure and disposed around the electromagnetic component 41. The magnetic component 42 and the electromagnetic component 41 are disposed radially opposite to each other to ensure that electromagnetic induction can be generated therebetween. To further decrease the peripheral size of the rotary support, a portion of the outer side wall of the bearing support 3 for disposing the electromagnetic component 41 can be determined as a structure recessed radially toward the central shaft. In such a case, the electromagnetic component 41 and the magnetic component 42 may be positioned close to the central shaft 2, thereby further decreasing the peripheral size of the rotary support. In addition, after the structure recessed radially toward the central shaft is formed on the outer side wall of the bearing support 3, a step portion is formed on the outer side wall of the bearing support 3. When the electromagnetic component 41 is mounted, an end surface of the electromagnetic component 41 can abut against the step portion to axially position the electromagnetic component 41.

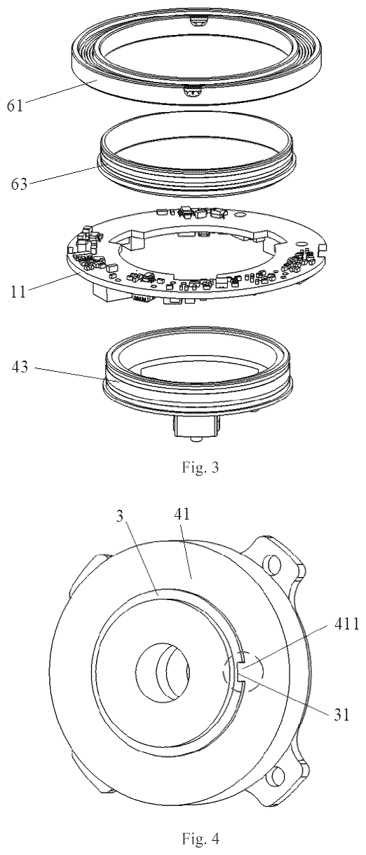

When the electromagnetic component 41 is fixed to the outer side wall of the bearing support 3, multiple fixing methods can be, for example, such as adhesion, threaded connection, snap-fit connection, welding, and other connection methods. When the snap-fit connection method is used, as shown in FIG. 4, a first snap-fit portion 411 can be disposed on the electromagnetic component 41, a second snap-fit portion 31 can be disposed on the bearing support 3, and the first snap-fit portion 411 is snap-fitted to the second snap-fit portion 31 to prevent the electromagnetic component 41 from rotating relative to the bearing support 3. In some embodiments, the first snap-fit portion 411 can be a protrusion, and the corresponding second snap-fit portion 31 being a slot; or the first snap-fit portion 411 can be a slot, and the corresponding second snap-fit portion 31 being a protrusion.

When the magnetic component 42 is fixed, the magnetic component 42 can be fixed using the stator fixing member 43. For example, the stator fixing member 43 can be fixed to the housing 1 first, and then the magnetic component 42 is fixed to the stator fixing member 43. As shown in FIG. 1 and FIG. 3, the stator fixing member 43 can be an annular bracket. The annular bracket is disposed around a periphery of the magnetic component 42 and is fixedly connected to the magnetic component 42. For example, a positioning step is formed on a side of the annular bracket toward the central shaft 2, and the magnetic component 42 is fixed on the positioning step by, for example, methods such as adhesion, threaded connection, snap-fit connection, and welding.

In some embodiments, the above electromagnetic component 41 can be an annular electromagnet. The electromagnet includes an iron core and a coil winding disposed around an outer side of the iron core. The magnetic component 42 can be an annular permanent magnet with a sine wave magnetic field filling its interior.

Since the electromagnetic component 41 is rotatable, power can be supplied to the electromagnetic component 41 using a wireless power supplier module 6. In addition to supplying the power to the electromagnetic component 41, the wireless power supplier module 6 can also supply power to other components that rotate with the bearing support 3 and require the power, such as a circuit board disposed on the bearing support 3 and components requiring the power in the detection device.

In some embodiments, wireless power supply can be implemented using electromagnetic induction. As shown in FIG. 1 and FIG. 3, the wireless power supplier module 6 can be disposed on the outer side of the driver 4. The wireless power supplier module 6 includes an emitting coil 61 and a receiving coil 62. Among them, the emitting coil 61 is fixed relative to the housing 1. The receiving coil 62 and the emitting coil 61 are axially disposed opposite to each other and can rotate with the bearing support 3. For example, during a setup process, the emitting coil 61, the driver 4, and the second bearing 52 can be determined to have substantially the same axial height; in addition, the emitting coil 61 can be disposed on the outer side of the stator fixing member 43, and the receiving coil 62 and the first bearing 51 can also be determined to have substantially the same axial height, thereby avoiding an increase in an axial height and enabling the receiving coil 62 to be spaced apart and disposed above the emitting coil 61. In such a case, during power supply, the emitting coil 61 can be electrically connected to an external power supply to supply power to the emitting coil 61. An alternating current flows into the emitting coil 61, the emitting coil 61 generates a varying magnetic field around it. This varying magnetic field induces a current in the receiving coil 62 to power the electromagnetic component 41 and other components, thereby achieving the wireless power supply to the electromagnetic component 41 and other components.

In some embodiments, in addition to the above electromagnetic induction wireless power supply method, the wireless power supplier module 6 can perform the wireless power supply using other methods, which are not described repeatedly herein.

As shown in FIG. 1, FIG. 2 and FIG. 3, the power can be supplied to the emitting coil 61 through a lower circuit board 11 fixed relative to the housing 1, and the lower circuit board 11 can be determined as an annular structure and disposed around the central shaft 2, the bearing 5 or the bearing support 3. For example, the stator fixing member 43 is disposed at a bottom of the housing 1 and is fixedly connected to the bottom, and the lower circuit board 11 is disposed on the stator fixing member 43, such that the lower circuit board 11 is fixed relative to the housing 1. The lower circuit board 11 is electrically connected to an external power supply to directly supply power to the emitting coil 61 via the lower circuit board 11. A circuit board that supplies the power to the emitting coil 61 is omitted in the axial direction in this structure. Accordingly, a height of the LiDAR is decreased.

In addition to supplying the power to the emitting coil 61, the above lower circuit board 11 can also supply power to other power-consuming components fixed relative to the housing 1. For example, the lower circuit board 11 can also supply power to an optical communication circuit board 12. The lower circuit board 11 is disposed around the central shaft 2 or the bearing 5 or the bearing support 3.

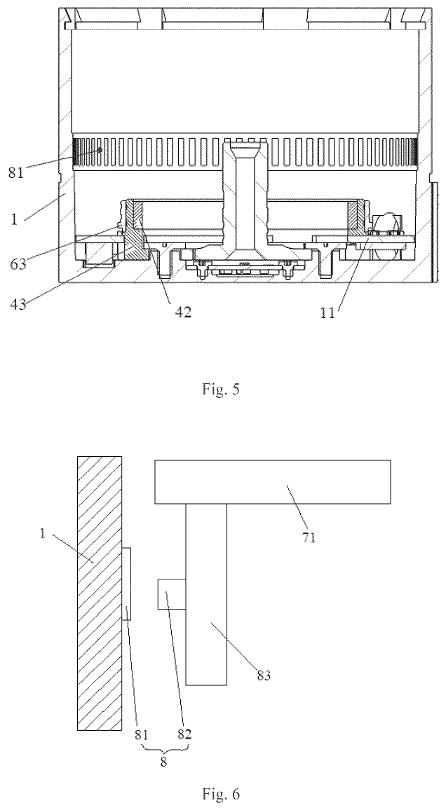

To fix the emitting coil 61, as shown in FIG. 1, FIG. 3, and FIG. 5, an emitting coil fixing member 63 can be disposed. For example, the emitting coil fixing member 63 can be determined as an annular structure and disposed around a peripheral surface of the above stator fixing member 43. The emitting coil 61 is disposed around a peripheral surface of the emitting coil fixing member 63. The emitting coil fixing member 63 can be fixed to the peripheral surface of the stator fixing member 43, and the emitting coil 61 is fixed to the peripheral surface of the emitting coil fixing member 63, that is, on a side away from the stator fixing member 43.

In addition, to reduce the number of components, the emitting coil 61 can also be directly fixed to the outer side of the stator fixing member 43. In such a case, the emitting coil 61 is fixed through the emitting coil fixing member 63 and the magnetic component 42 is directly fixed using the stator fixing member 43, thereby further decreasing the peripheral size of the rotary support.

When the above emitting coil fixing member 63 is fixed, the magnetic component 42 and the emitting coil fixing member 63 can both be disposed on the stator fixing member 43, then the stator fixing member 43 is fixed to the bottom of the housing 1, and the lower circuit board 11 is fixed on the stator fixing member 43, thereby implementing relative fixation of the emitting coil 61, the emitting coil fixing member 63, the magnetic component 42, the stator fixing member 43, the lower circuit board 11, and the housing 1. Due to the typically low strength of the circuit board, to improve the connection strength, the stator fixing member 43 can be fixedly connected to the bottom of the housing 1 by passing it through the lower circuit board 11. For example, during connection, methods such as adhesion, threaded connection, snap-fit connection, and welding can be used.

To reduce interference between the emitting coil 61 and the magnetic component 42, the emitting coil fixing member 63 can be made of an insulating material. In such a case, effective isolation can be formed between the emitting coil 61 and the magnetic component 42 to reduce electromagnetic interference between the emitting coil 61 and the magnetic component 42. For example, the emitting coil fixing member 63 can be made of a plastic material.

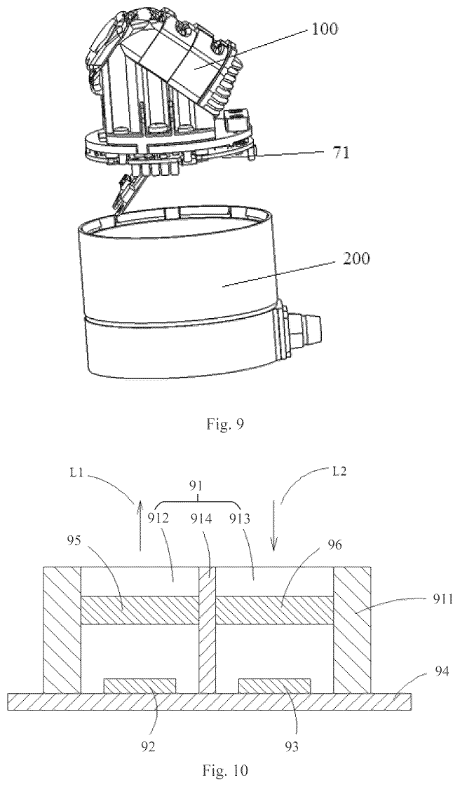

As shown in FIG. 1, FIG. 2, and FIG. 9, to mount and position the detection device 100 of the LiDAR, a rotary support member 7 can be disposed on the bearing support 3. The detection device 100 of the LiDAR is mounted on the rotary support member 7, such that during rotation, the bearing support 3 can drive the bearing support 7 and the detection device 100 to rotate synchronously. For example, the rotary support member 7 can be of an annular rotating support structure and disposed around the bearing support 3. The rotary support member 7 can be located above the driver 4 and the wireless power supplier module 6 and has substantially the same axial height as the first bearing 51.

To facilitate connection between the bearing support 3 and the rotary support member 7, a flange 32 can extend outwardly to the side wall of the bearing support 3. Then, the rotary support member 7 is connected to the flange 32. As shown in FIG. 2, the flange 32 includes an annular protrusion 321 protruding outward from the outer side wall of the bearing support 3 and multiple protrusions 322 protruding outward from the annular protrusion 321. Among them, multiple protrusions 322 can be provided with connection holes for connecting to the rotary support member 7 via the connection holes. The above flange 32 may be disposed at an axial end of the bearing support 3. In this case, there is a predetermined distance between the flange 32 and a first end surface (i.e., an upper end surface of the bearing support 3 in FIG. 1) of the bearing support 3. The rotary support member 7 is disposed between the flange 32 and the first end surface. The rotary support member 7 is axially supported by the flange 32, thereby saving axial space occupied by the rotary support member 7.

As shown in FIG. 1, the above receiving coil 62 can be fixed to an edge area of a lower surface of the rotary support member 7, and a recessed structure can be disposed on the lower surface of the rotary support member 7, such that at least part of the receiving coil 62 is embedded into the recessed structure, thereby further decreasing a height of the rotary support. In addition, a step formed by the recessed structure can also radially limit the receiving coil 62 to prevent the receiving coil 62 from radially moving, such that the receiving coil 62 is kept axially aligned with the emitting coil 61.

To detect rotational information of the detection device 100, rotating speed and a rotating angle of a motor are precisely controlled. As shown in FIG. 6, a position detector module 8 can be determined. The position detector module 8 includes a code disc 81 and a code reader 82. During mounting, one of the code disc 81 and the code reader 82 can be fixed relative to the housing 1 and the other one is fixed relative to the rotor, and the code disc 81 and the code reader 82 are disposed opposite to each other. In such a case, when the rotor rotates, information of a code track on the code disc 81 can be read by the code reader 82, thereby precisely controlling the rotating speed and the rotating angle of the motor. For example, during the setup process, a surface of the code disc 81 provided with the code track can be perpendicular to or parallel to the central shaft 2. When the surface of the code disc 81 provided with the code track is perpendicular to the central shaft 2, since a certain width is required to be reserved on the surface of the code disc 81 provided with the code track, certain radial space will be occupied, such that a radial peripheral size of the rotary support is larger. Accordingly, to save the radial space, as shown in FIG. 5 and FIG. 6, the code disc 81 is disposed around the inner surface of the side wall of the housing 1, such that the surface of the code disc 81 provided with the code track faces a direction of the central shaft 2. When the code track on the code disc 8 is determined, it can be determined that an extension direction of the code track is parallel to the central shaft 2. In addition, the code reader 82 is fixed relative to the rotary support member 7 and disposed radially opposite to the code disc 81. When the code reader 82 rotates with the rotary support member 7, the code track on the code disc 81 can be detected. In such a case, space occupied by the surface of the code disc 81 provided with the code track is transformed from the radial space into the axial space, thereby decreasing the peripheral size of the rotary support.

When the code reader 82 is fixed, the code reader 82 can be disposed on an upper circuit board 71. The upper circuit board 71 is disposed between the rotary support member 7 and the detection device 100 and rotates with the rotary support member 7. The upper circuit board 71 is further provided with a processor. The processor is electrically connected to the code reader 82 to process rotational position information acquired by the code reader 82 and receive and process a detection signal of the detection device 100. For example, as shown in FIG. 6, a code reader circuit board 83 is disposed below the upper circuit board 71, and the code reader 82 is disposed on the code reader circuit board 83. The upper circuit board 71 can be perpendicularly disposed relative to the central shaft 2, such that the detection device 100 can be connected conveniently. The code reader circuit board 83 can be disposed parallel to the central shaft 2. For example, an upper end of the code reader circuit board 83 can be connected to the upper circuit board 71. For example, a conductive hole can be opened at an edge of the code reader circuit board 83, then the code reader circuit board 83 can be welded to the upper circuit board 71 through the conductive hole. Among them, the conductive hole can be a circular hole, a semicircular hole or a hole in other shapes. The code reader 82 is disposed on an outer side surface of the code reader circuit board 83, such that a read end of the code reader 82 radially faces the code disc 81 outward. The processor of the upper circuit board 71 can process position information detected by the position detector module. In such a case, the number of elements on the lower circuit board, and the peripheral size and manufacturing costs of the lower circuit board can be decreased, thereby decreasing the peripheral size of the LiDAR.

When a gap between the code reader 82 and the code disc 81 is determined, on the premise of meeting a minimum reading distance requirement, the smaller the gap between the code reader 82 and the code disc 81, the better. For example, the gap can be determined to be less than an axial width of the code disc 81. In such a case, the radial space occupied by the position detector module 8 is decreased to a maximum extent.

As shown in FIG. 1, the rotary support further includes a middle circuit board 72. The middle circuit board 72 is disposed on the rotary support member 7 and located between the upper circuit board 71 and the lower circuit board 11. The middle circuit board 72 is disposed around the central shaft 2 or the bearing 5 or the bearing support 3. The receiving coil 62 of the wireless power supplier module 6 is also disposed on the rotary support member 7, and the receiving coil 62 and the middle circuit board 72 are disposed on two sides of the rotary support member 7, respectively. The receiving coil 62 of the wireless power supplier module 6 can supply power to the middle circuit board 72. The middle circuit board 72 is configured to supply power to the upper circuit board 71 and the electromagnetic component 41. The upper circuit board 71 is configured to supply power to the detection device 100. For example, as shown in FIG. 1 and FIG. 2, when the middle circuit board 72 is mounted, a recessed portion 73 can be disposed on an upper surface of the rotary support member 7. The middle circuit board 72 is disposed in the recessed portion 73 to decrease the radial space occupied by the middle circuit board 72 and effectively protect the middle circuit board 72. In addition, as shown in FIG. 2, one or more positioning pins 74 are further disposed in the recessed portion 73. Clearance notches 721 are disposed at positions of the middle circuit board 72 corresponding to the positioning pins 74, through which the positioning pins 74 pass. Similarly, as shown in FIG. 8, clearance notches 721 are also disposed at positions of the upper circuit board 71 corresponding to the positioning pins 74, through which the positioning pins 74 pass and are connected to the detection device 100. By determining the positioning pins 74, on the one hand, it can prevent the middle circuit board 72 and the upper circuit board 71 from rotating relative to the rotary support member 71, and on the other hand, it can directly fix the detection device with the rotary support member 7.

To achieve uplink optical communication and downlink optical communication of the LiDAR, as shown in FIG. 1, the housing 1 is further provided with an optical communication circuit board 12. The optical communication circuit board 12 is provided with an uplink wireless communication emitter and a downlink wireless communication receiver. The upper circuit board 71 is provided with an uplink wireless communication receiver and a downlink wireless communication emitter. Among them, the uplink wireless communication emitter and the uplink wireless communication receiver are configured to perform the uplink optical communication. Correspondingly, the downlink wireless communication emitter and the downlink wireless communication receiver are configured to perform the downlink optical communication. For example, the optical communication circuit board 12 can be disposed on a lower side of the lower circuit board 11 and located in a groove in the bottom of the housing. An opening of the groove faces upward. The central shaft 2 is located above the groove and shields the opening of the groove to effectively protect the optical communication circuit board 12. Moreover, the optical communication circuit board 12 does not occupy extra axial space, thereby reducing the height of the rotary support. In addition, the uplink optical communication and the downlink optical communication can both be implemented in the central shaft 2. In such a case, external interference can be shielded using the central shaft 2 to ensure signal communication quality while implementing the uplink optical communication and the downlink optical communication.

In some embodiments, as shown in FIG. 1, FIG. 2 and FIG. 3, the lower circuit board 11 and the middle circuit board 72 are provided with central holes and are disposed around the central shaft 2 or the bearing 5 or the bearing support 3. The rotary support member 7, the receiving coil 62, and the emitting coil 61 are sequentially disposed from top to bottom between the lower circuit board 11 and the middle circuit board 72. Moreover, the emitting coil 62, the emitting coil fixing member 63, the stator fixing member 43, the magnetic component 42, and the electromagnetic component 41 are sequentially disposed from outside to inside radially at the same height. The upper circuit board 71 and the optical communication circuit board 12 are disposed on an upper side and a lower side of the central shaft, respectively, and the upper circuit board 71 and the optical communication circuit board 12 are not provided with the central holes.

To sum up, a radial arrangement relationship of the portions of the rotary support is as follows. The driver 4, the wireless power supplier module 6, and the position detector module 8 are peripherally disposed around the central shaft 2, and the driver 4, the wireless power supplier module 6, and the position detector module 8 are sequentially disposed in a direction away from the central shaft 2. An axial arrangement relationship of the portions is as follows. The upper circuit board 71, the middle circuit board 72, the rotary support member 7, the wireless power supplier module 6 (and the driver 4), the lower circuit board 11, and the optical communication circuit board 12 are sequentially disposed axially from top to bottom.

In addition, the rotary support further includes the housing 1. The housing 1 is provided with the accommodating cavity. The portions of the rotary support can be disposed in the accommodating cavity of the housing 1. Among them, the code disc 81, the stator fixing member 43, the central shaft 2, and the optical communication circuit board 12 may be directly fixed to the housing 1, and other elements may not be directly connected to the housing.

In some embodiments, the above middle circuit board 72, the rotary support member 7, the magnetic component 42, the electromagnetic component 41, the stator fixing member 43, the emitting coil 61, the receiving coil 62, the emitting coil fixing member 63, and the lower circuit board 11 can be determined as annular structures; the upper circuit board 71 and the optical communication circuit board 12 can both be determined as circular structures. In addition, centers of circles of the above annular structures and centers of circles of the above circular structures are both located in the axial direction of the central shaft 2. In such a case, an overall structure is more symmetrical and compact, and rotating components are more stable during the rotation. Moreover, the structure of the housing 1 can be correspondingly determined as a cylindrical shape, occupying less space, thereby facilitating installation and use in equipment such as an automobile.

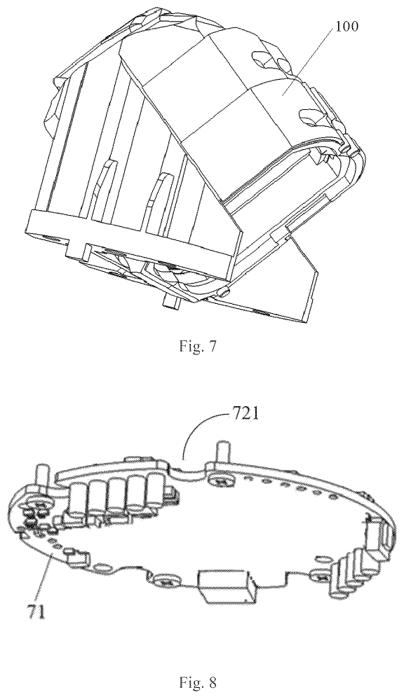

This disclosure provides some examples of a LiDAR, as shown in FIG. 7, FIG. 8, FIG. 9, and FIG. 10. The LiDAR includes a detection device 100 and a rotary support 200 in any one of the above embodiments. Among them, the detection device 100 is disposed on the rotary support 200. The rotary support drives the detection device to rotate 360° to detect a periphery of the LiDAR. For example, the detection device can be disposed on the rotary support member 7 of the rotary support, and the driver 4 of the rotary support drives the rotary support member 7 and the detection device 100 to rotate.

The detection device 100 can include a lens barrel 91, an optical emitter 92, an optical receiver 93, and a drive circuit board 94. The upper circuit board 71 of the rotary support 200 can be disposed at the bottom of the detection device 100. The upper circuit board 71 can be electrically connected to the middle circuit board 72 and the drive circuit board 94 of the detection device 100, respectively.

The optical emitter 92 and the optical receiver 93 are both disposed on the drive circuit board 94. The drive circuit board 94 is fixed to one side of the lens barrel 91. For example, in a light path direction of detection light L1, the lens barrel 91 is located downstream of the drive circuit board 94; or in a light path direction of echo light L2, the lens barrel 91 is located upstream of the drive circuit board 94. The optical emitter 92 is configured to emit the detection light L1, and the optical receiver 93 is configured to receive the echo light L2 reflected by a target object from the detection light L1. The lens barrel 91 is made of plastic. An emitting lens group 95 and a receiving lens group 96 are disposed in the lens barrel 91. The emitting lens group 95 is located on the light path of the detection light L1, and the receiving lens group 96 is located on the light path of the echo light L2.

This disclosure provides some examples where the detection device 100 for the LiDAR, the optical emitter 92, and the optical receiver 93 are all disposed on the same drive circuit board 94. The optical emitter 92 is configured to emit the detection light L1, which is shaped (for example, collimated) by the emitting lens group 95 before detecting a target object in an external environment of the LiDAR. The target object reflects detection light to form the echo light L2, and the echo light L2 is shaped (for example, focused) by the receiving lens group 96 and then received by the optical receiver 93. The above structure uses an emitter-receiver shared board, that is, the optical emitter and the optical receiver are disposed on the same drive circuit board. The drive circuit board is provided with drive circuits that drive the optical emitter to emit the detection light and drive the optical receiver to receive the echo light, respectively. In addition, in the structure of the emitter-receiver shared board, the lens barrel can use an emitter-receiver integrated design (e.g., an emitting lens barrel and a receiving lens barrel are merged into a single lens barrel). When the integrated lens barrel is mounted in cooperation with the emitter-receiver shared board of the optical emitter and the optical receiver, alignment-free assembly can be achieved, thereby facilitating the mass production. Moreover, the lens barrel is made of plastic, such that a weight of the lens barrel is decreased, processing costs are lowered, production efficiency is improved, and size consistency of a product is better.

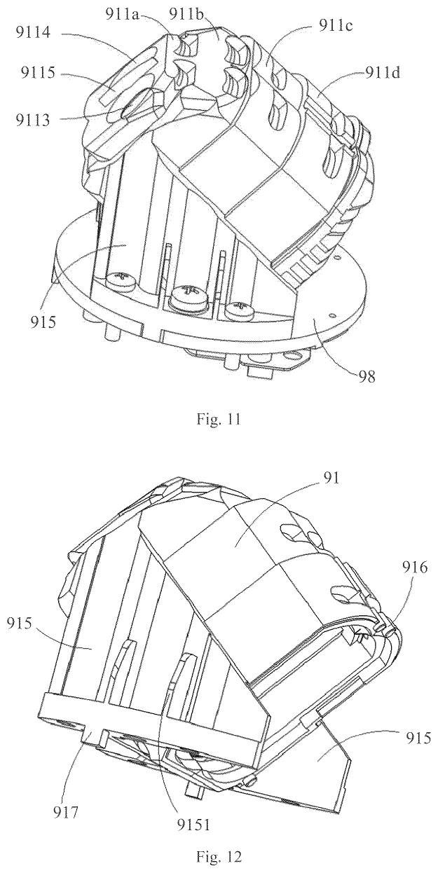

A structure of the lens barrel 91 is shown in FIG. 10, FIG. 11, and FIG. 12, including a lens barrel body 911, and an emitting cavity 912, a receiving cavity 913 and a first light barrier 914 formed in the lens barrel body 911. The emitting cavity 912 is configured to accommodate the emitting lens group 95. The receiving cavity 913 is configured to accommodate the receiving lens group 96. The first light barrier 914 is disposed between the emitting cavity 912 and the receiving cavity 913 to separate the emitting cavity 912 and the receiving cavity 913 to reduce interference between the detection light and the echo light, which may affect a detection result acquired by the detection device 100, such as a distance or a position of the target object. In such a case, an integrated lens barrel 91 is used, such that relative positions of the emitting lens group 95 and the receiving lens group 96 are fixed. Compared with a solution in which an independent emitting lens barrel and an independent receiving lens barrel are used and the emitting lens group 95 and the receiving lens group 96 are disposed in the emitting lens barrel and the receiving lens barrel, respectively, the integrated lens barrel 91 facilitates the assembly and debugging. In addition, when the lens barrel 91 is assembled, the assembly of multiple parts is reduced, such that an assembly process of the lens barrel 91 is simplified, production and assembly efficiency is improved, and the mass production is facilitated.

The above first light barrier 914 can be integrally formed with the lens barrel body 911. The first light barrier 914 can be made of the same plastic material as the lens barrel body 911 and can be integrally formed using an injection molding process. This approach can simplify production and assembly processes. Moreover, an integrally formed structure is higher in strength and durability, thereby improving reliability of the LiDAR during long-time rotation and prolonging a service life of the LiDAR.

In an embodiment of sharing one drive circuit board 94 by the above optical emitter 92 and the optical receiver 93, the optical emitter 92 can use a vertical cavity surface emitting laser (VCSEL). The optical receiver 93 can use a single-photon detector, such as a silicon photomultiplier (SiPM) and a single photon avalanche diode (SPAD).

Since photon detection efficiency (PDE) of the single-photon detector used by the LiDAR is significantly improved, luminous power of a laser does not need to be excessively high, resulting in decreased luminous power of VCSEL. In such a case, power consumption of both the optical emitter 92 and the optical receiver 93 is decreased. Accordingly, heat dissipation requirements on the optical emitter and the optical receiver are not high. Heat dissipation can be performed without relying on a metal lens barrel 91, such that the lens barrel 91 can be made of the plastic material, thereby decreasing the weight of the lens barrel 91, lowering the manufacturing costs, improving the production efficiency, and resulting in better size consistency of the product.

Since VCSEL emits the detection light in a direction perpendicular to the drive circuit board 94 and the single-photon detector receives the echo light in a direction perpendicular to the drive circuit board 94, an emitting light path of the detection light emitted by the optical emitter 92 is parallel to a receiving light path of the echo light received by the optical receiver 93. Correspondingly, an optical axis of the emitting lens group 95 is parallel to an optical axis of the receiving lens group 96, such that the emitting cavity 912 and the receiving cavity 913 in the lens barrel body 911 are both disposed in a direction perpendicular to the drive circuit board 94, thereby saving space occupied by the emitting cavity 912 and the receiving cavity 913. In addition, since the emitting light path of the optical emitter 92 and the receiving light path of the optical receiver 93 are both perpendicular to the drive circuit board 94, and no beam deflecting elements (e.g., mirrors) are disposed outside the lens barrel 91, a light path of the detection light L1 and a light path of the echo light L2 are linearly transmitted in the LiDAR without deflection.

In some embodiments, the above emitting lens group 95 may include one or more emitting lenses. When multiple emitting lenses are included, the multiple emitting lenses are sequentially arranged along the light path of the detection light L1, and outer diameter sizes of the emitting lenses are different. Similarly, the above receiving lens group 96 may include one or more receiving lenses. When multiple receiving lenses are included, the multiple receiving lenses are sequentially arranged along the light path of the echo light L2, and outer diameter sizes of the receiving lenses are different.

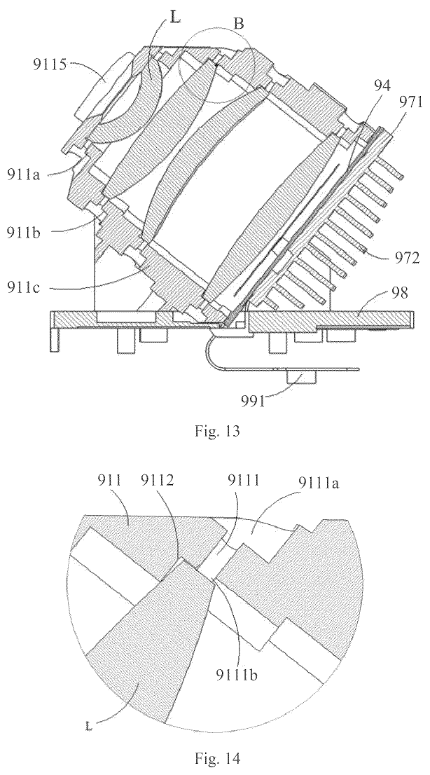

As shown in FIG. 11 and FIG. 13, the lens barrel body 911 may comprise multiple lens barrel sections (for example, 911a, 911b, 911c, and 911d) in a direction perpendicular to the drive circuit board 94. Inner diameters of the lens barrel sections are different to accommodate lenses (for example, emitting lenses or receiving lenses) of different sizes. As shown in FIG. 13, sizes of emitting lenses in the emitting lens group 95 are different, and the outer diameters of the emitting lenses in a transmission direction of the detection light LI sequentially decrease. Correspondingly, sizes of receiving lenses in the receiving lens group 96 are different, and the outer diameters of the receiving lens in a transmission direction of the echo light L2 sequentially increase. In this case, if outer diameter sizes of the lens barrel sections are the same, wall thicknesses of the lens barrel sections will differ, resulting in inconsistent strength of the lens barrel body 911 throughout in the direction perpendicular to the drive circuit board 94, and the lens barrel sections with a relatively small wall thickness are prone to deformation. Accordingly, the outer diameter sizes of the lens barrel sections can be determined to match the inner diameter sizes thereof, that is, the lens barrel sections with a larger inner diameter have a larger outer diameter, while the lens barrel sections with a smaller inner diameter have a smaller outer diameter. In such a case, the wall thicknesses of the lens barrel sections are approximately equal, such that it can ensure that the strength of the lens barrel body 911 throughout in the direction perpendicular to the drive circuit board 94 is uniform, thereby reducing local deformation of the lens barrel body 911. In some embodiments, the above stepped lens barrel structure can be implemented by the injection molding process when using the plastic material. However, the lens barrel can be formed by mechanical machining when using a metal material, making it difficult to implement, costly, and resulting in poor dimensional consistency, which is unfavorable for mass production.

To ensure stability of optical performance, a lens L (including the emitting lens group 95 and the receiving lens group 96) and the lens barrel body 911 can be adhered using an adhesive. A structure of the lens barrel 91 is shown in FIG. 13 and FIG. 14. A channel 9111 is disposed on a side wall of the lens barrel body 911. An inlet end 9111a of the channel 9111 is in communication with an outside of the lens barrel body 911, and an outlet end 9111b of the channel 9111 is in communication with a lens in the lens barrel body 911 to guide the adhesive to enter a connection between the lens L and the lens barrel body 911. When the lens L is mounted, the lens can first be placed at a preset mounting position in the lens barrel body 911. The mounting position can be positioned by using a step structure 9112 formed on an inner wall of the lens barrel body 911. After the lens L is placed, the adhesive is guided into the channel 9111 and extruded into a contact part between the lens L and the lens barrel body 911, thereby adhering the lens L in the lens barrel body 911.

To facilitate the adhesive entering the inlet end 9111a of the channel 9111, as shown in FIG. 13 and FIG. 14, a cross-sectional area of the inlet end 9111a of the channel 9111 can be set to be larger than a cross-sectional area inside the channel 9111. For example, when the channel 9111 is a circular through hole, a diameter of the inlet end 9111a of the channel 9111 is greater than an inner diameter of the channel 9111. In such a case, accommodating space of the inlet end 9111a is relatively large, such that the adhesive may enter the channel 9111 more easily. Therefore, larger operating space is reserved, work efficiency is improved, and appearance is maintained by reducing adhesive spillage.

As shown in FIG. 11 and FIG. 13, the lens barrel body 911 further includes an emitting port 9113 and a receiving port 9114. The emitting port 9113 is located downstream of the emitting cavity 912 in a direction of the light path of the detection light to enable the detection light to be emitted from the emitting cavity 912, and the receiving port 9114 is located upstream of the receiving cavity 913 in a direction of the light path of the echo light to enable the echo light to enter the receiving cavity 913. To reduce mutual interference between the detection light and the echo light at the emitting port 9113 and the receiving port 9114, a mounting portion can also be disposed on an end surface of the lens barrel body 911 where the exit port 9113 and the receiving port 9114 are disposed. The mounting portion is located between the emitting port 9113 and the receiving port 9114. A second light barrier 9115 is disposed at the mounting portion to separate the detection light outside the emitting port 9113 and the echo light outside the receiving port 9114 to reduce the mutual interference between the detection light and the echo light. The second light barrier 9115 can use a light barrier plate, and the light barrier plate can be disposed perpendicular to an end surface of the lens barrel body 911.

In some embodiments, the lens barrel 91 can be made of a fiber-enhanced polyphenylene sulfide (PPS) plastic. Compared with a regular PPS plastic, the fiber-enhanced PPS plastic can improve corresponding performance of a material based on actual needs. For example, a glass fiber-enhanced PPS plastic, a glass mineral fiber-enhanced PPS plastic or a carbon fiber-enhanced PPS plastic can be selected. Among them, the glass fiber-enhanced PPS plastic is formed by adding glass fibers into the PPS plastic. The glass fibers have advantages of high mechanical strength, good insulating property, corrosion resistance, high-temperature resistance, or the like. Therefore, the PPS plastic can have the above performance. For example, a content of added glass fibers can be 40%, which is a mass percentage, such that parameters of the glass fiber-enhanced PPS plastic are more suitable for manufacturing the lens barrel 91.

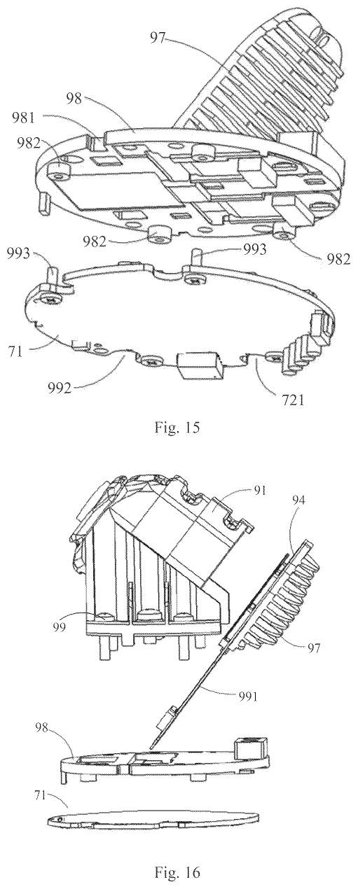

To achieve a better heat dissipation effect, as shown in FIG. 13 and FIG. 15, a heat dissipation member 97 can be disposed at an end of the lens barrel 91. The heat dissipation member 97 can be thermally connected to the drive circuit board 94 to dissipate heat of the drive circuit board 94. The heat dissipation member 97 can also be thermally connected to the lens barrel 91 to dissipate heat of the lens barrel 91. The heat dissipation member 97 can also be thermally connected to both the drive circuit board 94 and the lens barrel 91 to dissipate heat of both the lens barrel 91 and the drive circuit board 94 at the same time. When the heat of both the lens barrel 91 and the drive circuit board 94 is dissipated, as shown in FIG. 12 and FIG. 13, the drive circuit board 94 can be disposed between the lens barrel 91 and the heat dissipation member 97, and a first positioning portion 916 of the lens barrel 91 passes through the drive circuit board 94 and is connected to the heat dissipation member 97 to position and fixedly connect the lens barrel 91, the drive circuit board 94, and the heat dissipation member 97. Therefore, the heat of both the drive circuit board 94 and the lens barrel 91 is dissipated by the heat dissipation member 97.

For example, as shown in FIG. 13, a structure of the heat dissipation member 97 can include a substrate 971 and a heat dissipation fin group 972. The heat dissipation fin group 972 consists of multiple parallel heat dissipation fins. The heat dissipation fins are of sheet structures and are perpendicular to the substrate 971. The multiple heat dissipation fins are arranged in a direction parallel to the substrate 971. A gap is formed between two adjacent heat dissipation fins, such that a contact area between the heat dissipation member 97 and air is increased, thereby improving heat conduction efficiency between the heat dissipation member 97 and the air. Heights of the multiple heat dissipation fins on the substrate 971 can be the same or different. In a solution shown in FIG. 13, the heights of the multiple heat dissipation fins on the substrate 971 gradually decrease from the middle to two sides. In such a case, mutual shielding between the heat dissipation fins can be decreased, full contact between external air and each of the multiple heat dissipation fins is facilitated, thereby improving the heat dissipation efficiency.

As shown in FIG. 13, FIG. 15, and FIG. 16, to facilitate fixation of the detection device 100, a base 98 can be disposed at the bottom of the lens barrel 91. The base 98 is configured to connect the detection device 100 to the rotary support for the LiDAR, such that the rotary support drives the detection device 100 to rotate. To increase a vertical field of view range of the LiDAR, the optical axis of the emitting lens group 95 and the optical axis of the receiving lens group 96 in the lens barrel 91 are obliquely disposed relative to the base 98, that is, the emitting cavity 912 and the receiving cavity 913 are obliquely disposed relative to the base 98. In such a case, the detection device 100 can be away from the base 98 in a direction of the vertical field of view, thereby increasing a detection range of the detection device 100 in the direction of the vertical field of view. For example, when tilt angles of the optical axis of the emitting lens group 95 and the optical axis of the receiving lens group 96 are determined, the vertical field of view of the detection device 100 can be greater than or equal to 105°.

There are multiple connection methods between the lens barrel 91 and the base 98. For example, the obliquely disposed lens barrel body 911can be directly connected to the base 98 in an oblique manner. In addition, in another connecting method, as shown in FIG. 11 and FIG. 12, support bodies 915 can be disposed on two sides of the lens barrel body 911, where the lens barrel body 911 is obliquely disposed relative to the base 98, and the support bodies 915 are integrally formed with the lens barrel body 911 and are perpendicularly connected to the base 98. The support bodies 915 are configured to support the lens barrel body 911, the drive circuit board 94, and the heat dissipation member 97. In this case, the barrel lens body 911 is still obliquely disposed. Due to an existence of the support bodies 915, the support bodies 915 are disposed in a direction perpendicular to the base 98 and located on two sides of the barrel lens body 911, the inclined barrel lens body 911 can be connected to the base 98 in the direction perpendicular to the base 98, resulting in a larger contact area and a more stable connection between the lens barrel 91 and the base 98.

In some embodiments, the support bodies 915 can be implemented using plate-like, columnar, or block-shaped structures. As shown in FIG. 12, when the support bodies 15 use the plate-like structures, to reduce the deformation of the support bodies 915, reinforcing ribs 9151 can also be disposed on side surfaces of the support bodies 915. The bottom of each of the reinforcing ribs 9151 abuts against the base 98, thereby making connection between the support bodies 915 and the base 98 more stable and reducing the deformation of the support bodies 915.

In some embodiments, all of the above lens barrel body 911, the support bodies 915, and the reinforcing ribs 9151 can be made of the plastic material when integrally formed, and can be integrally formed by the injection molding process. This approach can simplify the production and assembly processes.

To position the lens barrel 91 and the drive circuit board 94 and position the lens barrel 91 and the heat dissipation member 97, the first positioning portion 916 can be disposed between the lens barrel 91 and the drive circuit board 94 and between the lens barrel 91 and the heat dissipation member 97. The lens barrel 91 and the drive circuit board 94 are positioned and the lens barrel 91 and the heat dissipation member 97 are positioned through the first positioning portion 916. There are multiple methods to implement the first positioning portion 916. For example, a positioning protrusion can be disposed at an end of the lens barrel body 911, positioning holes are determined on the drive circuit board 94 and the heat dissipation member 97, and the positioning protrusion passes through the positioning holes for positioning. In addition, through holes for threading screws can also be determined at the end of the lens barrel body 911, threaded holes are determined on the drive circuit board 94 and the heat dissipation member 97, and the screws pass through the through holes and are threadedly connected to the threaded holes to implement positioning connections between the lens barrel 91 and the drive circuit board 94 and between the lens barrel 91 and the heat dissipation member 97.

In addition, as shown in FIG. 12, to position the lens barrel 91 and the base 98, a second positioning portion 917 can be disposed between the lens barrel 91 and the base 98, and the lens barrel 91 and the base 98 are positioned through the second positioning portion 917. There are also various methods to implement the second positioning portion 917. For example, positioning protrusions may be disposed at bottoms of the support bodies 915, positioning holes are determined on the base 98, or the positioning protrusions can be disposed on the base 98, the positioning holes are determined at the bottoms of the support bodies 915, and the positioning protrusions pass through the positioning holes for positioning. In addition, through holes for threading screws can also be determined at the bottoms of the support bodies 915, threaded holes are determined on the base 98, and the screws pass through the through holes and are threadedly connected to the threaded holes to implement a positioning connection between the lens barrel 91 and the base 98.

To position the lens barrel 91 and the base 98, as shown in FIG. 12 and FIG. 15, the second positioning portion 917 can use a positioning protrusion in FIG. 12. A first positioning recess 981 is disposed on the base 98, and the second positioning portion 917 passes through the first positioning recess 981 to implement positioning between the lens barrel 91 and the base 98. In addition, as shown in FIG. 15, the base 98 and the upper circuit board 71 are capable of being connected in a mating manner. For example, a threaded hole column 982 can be disposed on the base 98, a first screw 993 is disposed on the upper circuit board 71, and the base 98 and the upper circuit board 71 are fixedly connected through a threaded fit between the first screw 993 and the threaded hole column 982.

In some embodiments, the positioning pins 74 pass through the clearance notches 721 and are then connected to the detection device 100. For example, the positioning pins 74 pass through the clearance notches 721 and then sequentially pass through the holes on the base 98 and the lens barrel 91. As shown in FIG. 16, threaded holes can be formed in the positioning pins 74. The rotary support member 7, the upper circuit board 71, the base 98, and the lens barrel 91 can be fixedly connected through a threaded fit between second screws 99 and the positioning pins 74. Therefore, on the one hand, the middle circuit board 72 and the upper circuit board 71 are prevented from rotating relative to the rotary support member 7, and on the other hand, the detection device 100 can be directly fixed to the rotary support member 7.

In some embodiments, since the lens barrel 91 is made of the plastic, in the above embodiments, the first positioning portion 916 and the second positioning portion 917 disposed on the lens barrel 91 can both be integrally formed with the plastic lens barrel 91 by injection molding, thereby decreasing the number of parts and facilitating improvement of the production efficiency.

In some embodiments, the upper circuit board 71 can be electrically connected to the drive circuit board 94 to process a detection signal received by the drive circuit board 94. For example, as shown in FIG. 13, FIG. 15, and FIG. 16. For example, during the connection, the upper circuit board 71 can be disposed on one side of the base 98 away from the lens barrel 91, a hole is determined on the base 98, and the drive circuit board 94 is electrically connected to the upper circuit board 71 through an electrical connector 991 passing through the hole. Since the lens barrel 91 is obliquely disposed relative to the base 98, the drive circuit board 94 is also obliquely disposed relative to the base 98. The above electrical connector 991 can be implemented using a transmission line, a circuit board or a flexible flat cable. When the flexible flat cable is used, multiple lines are integrated with an ordered structure. The flexible flat cable can pass through the base 98, be bent, and then be electrically connected to the upper circuit board 71. In this case, the electrical connector 991 is located between the base 98 and the upper circuit board 71, and the electrical connector 991 is parallel to the base 98, thereby saving space and decreasing an overall size of the LiDAR.

In some examples of the LiDAR provided by the embodiments of this disclosure, the rotary support in any one of the above embodiments can be used. The peripheral size of the rotary support can be decreased, such that the peripheral size of the LiDAR is decreased without affecting the performance of the LiDAR, thereby facilitating the assembly and the mass production of the LiDAR.

In some examples of the LiDAR provided by the embodiments of this disclosure, the detection device 100 in any one of the embodiments can be used. In this way, a weight of the LiDAR can be decreased, and pressure on the rotary support 200 can be decreased, such that rotating stability of the rotary support 200 is improved. Moreover, costs of the LiDAR can be lowered, and the production efficiency of the LiDAR can be improved, thereby facilitating the mass production of the LiDAR.

The above LiDAR can also include a window. The window is disposed on the housing 1 and configured to enable the detection light to transmit outside the LiDAR and the echo light to transmit into the LiDAR, and is fixedly connected to the housing 1. In such a case, various elements inside the LiDAR are accommodated by the fixedly connected housing 1 and window. Various elements can include the detection device 100 and other elements, except for the housing 1, in the rotary support 200.

Specific embodiments of this disclosure have been described above. Other embodiments are within a scope of appended claims. In some cases, actions or steps recited in the claims may be performed in a different order than that in the embodiments and still achieve a desired result. In addition, processes depicted in the accompanying drawings do not necessarily need to be shown in a specific order or a continuous order to achieve the desired result. In some embodiments, multi-task processing and parallel processing are also feasible or potentially beneficial.

In summary, once reading this detailed disclosure, those skilled in the art can understand that the foregoing detailed disclosure can be presented merely as an example, and may not be limiting. Although it is not explicitly stated herein, those skilled in the art can understand that needs of this disclosure encompass various reasonable changes, improvements, and modifications to the embodiments. These changes, improvements, and modifications are intended to be proposed by this disclosure and are within the spirit and scope of exemplary embodiments of this disclosure.

In addition, some terms in this disclosure have been used to describe the embodiments of this disclosure. For example, at least one of “one embodiment,” “an embodiment,” or “some embodiments” means that specific features, structures, or characteristics described combined with this embodiment can be included in at least one of the embodiments of this disclosure. Therefore, it can be emphasized and understood that references to two or more of “an embodiment,” or “one embodiment,” or “an alternative embodiment” in various parts of this disclosure do not necessarily all refer to the same embodiment. In addition, the specific features, structures or characteristics can be appropriately combined in one or more of the embodiments of this specification.

It should be understood that in the foregoing description of the embodiments of this disclosure, to help understand one feature, this disclosure combines various features in a single embodiment, accompany drawings or description thereof for a purpose of simplifying this disclosure. However, this does not mean that a combination of these features is mandatory. Those skilled in the art can well extract some of these features and construe them as separate embodiments when reading this disclosure. That is to say, the embodiments of this disclosure can also be understood as integration of multiple secondary embodiments. Moreover, it is also valid when a content of each secondary embodiment is less than all features of a single aforementioned disclosed embodiment.

Every patent, patent application, publication of patent application, and other materials cited herein, such as papers, books, specification, publications, documents, and articles, can be incorporated herein by reference. All contents used for all purposes, except any history of prosecution documents related thereto, any identical history of prosecution documents that can be inconsistent or conflict with this document, or any identical history of prosecution documents that can have a limited influence on a broadest scope of the claims, are associated with this document currently or in the future. For example, if there is any inconsistency or conflict between at least one of description, definition or use of terms associated with any contained material and at least one of terms, description, definition or use related to this document, terms in this document shall prevail.

Terms “or” and “and/or” used in this disclosure are intended to describe a relationship between associated objects, and they represent non-exclusive inclusion. For example, “A and/or B” and “A or B” may each include: “A alone,” “B alone,” or “A and B,” where “A” and “B” may each include a single object or multiple objects. As another example, “A, B and/or C,” “A, B or C” and “A, B and C” each may include: “A alone,” “B alone,” “C alone,” “A and B,” “A and C,” “B and C,” or “A, B and C,” where “A,” “B” and “C” may each include a single object or multiple objects. In addition, a character “/” in this disclosure represents an “or” relationship between related objects before and after it. In this disclosure, expressions “at least one of A or B” and “one or more of A and B” shall have the same meaning as the aforementioned expression “A or B”, and expressions “one or more of A, B and C” and “at least one of A, B or C” shall have the same meaning as the aforementioned expression “A, B or C”. An expression “one or more of A, B and C” shall have the same meaning as the aforementioned expression “A, B or C”.

It should be further noted that a content of BACKGROUND merely represents information known to inventor(s) personally, and does not indicate that the aforesaid information has entered a public domain prior to a publication date of this disclosure, nor does it suggest that such information may constitute the prior art of this disclosure.

Finally, it should be understood that the embodiments disclosed herein are illustrative of principles of the embodiments set forth in this disclosure. Other modified embodiments are also within a scope of this disclosure. Therefore, the embodiments disclosed in this disclosure are merely examples rather than limitations. Those skilled in the art may adopt alternative configurations based on the embodiments set forth in this disclosure to implement this disclosure contained herein. Accordingly, the embodiments of this disclosure are not limited to those accurately described in this disclosure.

1.-48. (canceled)

49. A rotary support (200) for a LiDAR, comprising:
a housing (1), provided with an accommodating cavity;
a central shaft (2), disposed in the accommodating cavity and fixed relative to the housing (1);
a bearing support (3), disposed in the accommodating cavity and mated with the central shaft via a bearing (5), such that the bearing support (3) is capable of rotating relative to the central shaft (2); and
a driver (4), disposed in the accommodating cavity and configured to drive the bearing support (3) to rotate, wherein the driver (4) comprises a stator and a rotor, the rotor comprises an electromagnetic component (41), the electromagnetic component (41) is fixed to an outer side wall of the bearing support (3), and the stator comprises a magnetic component (42), the magnetic component (42) is disposed on an outer side of the electromagnetic component (41) and fixed relative to the housing (1).

50. The rotary support (200) of claim 49, further comprising:
a stator fixing member (43), fixed relative to the housing (1), wherein the magnetic component (42) is fixed to the stator fixing member (43).

51. The rotary support (200) of claim 49, further comprising:
a rotary support member (7), fixed relative to the bearing support (3), wherein a detection device (100) of the LiDAR is mounted on the rotary support member (7).

52. The rotary support (200) of claim 51, wherein the housing (1) comprises a bottom and a side wall disposed around the bottom, the rotary support (200) further comprises a position detector module (8), configured to detect rotational position information of the detection device (100) and the position detector module (8) comprising:
a code disc (81), disposed around an inner surface of the side wall and provided with a code track; and
a code reader (82), fixed relative to the rotary support member (7) and disposed radially opposite to the code disc (81), wherein the code reader (82) rotates with the rotary support member (7) to detect the code track on the code disc (81).

53. The rotary support (200) of claim 52, wherein an extension direction of the code track is parallel to the central shaft (2).

54. The rotary support (200) of claim 52, wherein an upper circuit board (71) is disposed between the rotary support member (7) and the detection device (100), and the code reader (82) is fixed on the upper circuit board (71).

55. The rotary support (200) of claim 54, wherein a code reader circuit board (83) is disposed below the upper circuit board (71), and the code reader (82) is disposed on the code reader circuit board (83).

56. The rotary support (200) of claim 55, wherein the upper circuit board (71) is perpendicular to the central shaft (2), and the code reader circuit board (83) is parallel to the central shaft (2).

57. The rotary support (200) of claim 54, further comprising a middle circuit board (72) and the lower circuit board (11), wherein the middle circuit board (72) is disposed on the rotary support member (7) and located between the upper circuit board (71) and the lower circuit board (11), the middle circuit board (72) is disposed around the central shaft (2) or the bearing (5) or the bearing support (3), and the middle circuit board (72) is capable of supplying power to the upper circuit board (71) and the electromagnetic component (41).

58. The rotary support (200) of claim 52, wherein a gap between the code reader (82) and the code disc (81) is smaller than a width of the code disc (81) in an axial direction.

59. The rotary support (200) of claim 52, wherein the driver (4), a wireless power supplier module (6), and the position detector module (8) are disposed around the central shaft (2), and the driver (4), the wireless power supplier module (6), and the position detector module (8) are sequentially disposed in a direction away from the central shaft (2).

60. A LiDAR, comprising:
the rotary support (200) of claim 49; and
a detection device (100), disposed on the rotary support (200), wherein the rotary support (200) drives the detection device (100) to rotate to detect a periphery of the LiDAR.

61. The LiDAR of claim 60, wherein the detection device (100) comprises:
a lens barrel (91), configured to accommodate an emitting lens group (95) and a receiving lens group (96), wherein the lens barrel (91) is made of plastic;
an optical emitter (92), configured to emit detection light, wherein the emitting lens group (95) is located on a light path of the detection light;
an optical receiver (93), configured to receive echo light reflected by a target object from the detection light, wherein the receiving lens group (96) is located on a light path of the echo light; and
a drive circuit board (94), wherein the optical emitter (92) and the optical receiver (93) are both disposed on the drive circuit board (94); wherein the barrel lens (91), comprising:
a barrel lens body (911), comprising:
an emitting cavity (912), formed in the lens barrel body (911) and configured to accommodate the emitting lens group (95); and
a receiving cavity (913), formed in the lens barrel body (911) and configured to accommodate the receiving lens group (96); and
a first light barrier (914), disposed between the emitting cavity (912) and the receiving cavity (913) to separate the emitting cavity (912) and the receiving cavity (913);
wherein the lens barrel body (911) and the first light barrier (914) are integrally formed.

62. The LiDAR of claim 61, wherein the lens barrel body (911) comprises a plurality of lens barrel sections in a direction perpendicular to the drive circuit board (94), inner diameters of the lens barrel sections being different to match at least one of emitting lenses or receiving lenses of different sizes, and wall thicknesses of the lens barrel sections being the same.

63. The LiDAR of claim 61, wherein the lens barrel body (911) comprises:
an emitting port (9113), located on a light path of the detection light and located downstream of the emitting cavity (912);
a receiving port (9114), located on a light path of the echo light and located upstream of the receiving cavity (913);
a mounting portion, located between the emitting port (9113) and the receiving port (9114); and
a second light barrier (9115), mounted outside the lens barrel body (911) through the mounting portion, to isolate the detection light and the echo light outside the lens barrel body (911).

64. The LiDAR of claim 61, wherein the lens barrel (91) is made of a fiber-enhanced polyphenylene sulfide (PPS) plastic.

65. The LiDAR of claim 61, wherein the detection device (100) further comprises a heat dissipation member (97), wherein the heat dissipation member (97) is disposed at an end of the lens barrel (91) and configured to dissipate heat of at least one of the drive circuit board (94) and the lens barrel (91);
wherein the drive circuit board (94) is disposed between the lens barrel (91) and the heat dissipation member (97).

66. The LiDAR of claim 61, wherein the detection device (100) further comprises a base (98), wherein the lens barrel (91) is mounted on the base (98);
wherein the optical axis of the emitting lens group (95) and the optical axis of the receiving lens group (96) in the lens barrel (91) are obliquely disposed relative to the base (98).

67. The LiDAR of claim 66, wherein the lens barrel (91) comprises:
the lens barrel body (911), obliquely disposed relative to the base (98); and
support bodies (915), integrally formed with the lens barrel body (911) and connected to the base (98), wherein the support bodies (915) are disposed on two sides of the lens barrel body (911) and configured to support the lens barrel body (911), the drive circuit board (94), and the heat dissipation member (97).

68. The LiDAR of claim 66, wherein the upper circuit board (71) is disposed on one side of the base (98) away from the lens barrel (91), the drive circuit board (94) is provided with an electrical connector (991), the base (98) is provided with a hole, and the electrical connector (991) passes through the hole and is electrically connected to the upper circuit board (71).
